(19) United States
(12) Patent Application Publication
(10) Pub. No.: US 2018/0073546 A1
(43) Pub. Date: Mar. 15, 2018

(54) A SAFETY DEVICE FOR VEHICLE WHEELS

(71) Applicant: Giuseppe ZECCHI, San Casciano in Val di Pesa (Firenze) (IT)

(72) Inventor: Giuseppe ZECCHI, San Casciano in Val di Pesa (Firenze) (IT)

(21) Appl. No.: 15/554,748

(22) PCT Filed: Mar. 18, 2016
(86) PCT No.: PCT/IB2016/051540

§ 371 Date: Aug. 31, 2017

(30) Foreign Application Priority Data
Mar. 18, 2015 (IT) FI2015A000076

(51) Int. Cl. F16B 39/10; B60B 3/16; F16B 41/00

(52) U.S. Cl. CPC F16B 39/10; B60B 2900/3312; F16B 41/005; B60B 3/165

(57) ABSTRACT

The present invention relates to a novel safety device for motor vehicles wheels, in particular a device for locking the wheel nuts, able to effectively prevent their rotation and consequent spontaneous unscrewing, which may cause serious accidents.

### FIELD OF THE INVENTION

The present invention relates to the field of vehicle wheels, and more in particular it relates to a safety device for locking the wheel nuts of vehicles, and to the related method of use.

### STATE OF THE ART

The problem of wheel nuts loosening in motor vehicles is a problem known for decades and relatively frequent, particularly among heavy vehicles that travel long distances; this problem may also be responsible for the detachment of wheels thus causing serious accidents.

Heavy commercial vehicles, industrial off-road vehicles operating on uneven surfaces, and regular or tourism buses are transports more prone to this problem. On such vehicles, even before arriving at the wheel detachment, the loosening of the fastening nuts can create a series of more or less serious and expensive drawbacks, ranging from a greater wear of the various components of the wheels, including the tires, to maintenance costs increased for the constant control of a correct screwing of the nuts in order to ensure an acceptable level of safety. The misalignment of the wheels resulting from the loosening of nuts can also let them to disengage from the vehicle and cause an accident.

The reasons that lead to nuts loosening can be manifold: in addition to non-optimal conditions of the roads and to the vibrations that they generate on the components of vehicles, also the repeated braking and accelerations of the vehicles under normal operating conditions, the losses of oil from the motor axis, an incorrect installation of the wheels, or an insufficient tightening made on components not cleaned up, may contribute to the nuts loosening.

To overcome this problem have been proposed in the past various types of anti-unscrewing nuts, for instance those consisting of nuts fitted with knurled washers that, thanks to the friction on the bearing surfaces, block the rotation of nuts. In daily reality, however, such systems have proved to be not very effective on vehicles exposed to strong vibrations and in particular not able to ensure the required safety for vehicles for the public transport of people, without providing for a continuous, and excessively expensive, maintenance. The need for an ongoing maintenance, as well as the related considerable costs, is highly prone to human error and requires a commitment of considerable human resources.

It is just to facilitate such maintenance operations and to increase safety that systems have been proposed able to highlight when the wheel nuts of a vehicle have undergone a rotation with respect to their regular mounting position, and when they require therefore to be checked and retightened.

They are indicators, for example in the form of a cap or a ring adapted to be mounted directly on the nut and provided on one side with an arrow that, by rotating along with the nut, visually indicates if the nut has moved or not from the correct starting position. To increase the effectiveness, these devices have been made in fluorescent plastic, so that it can be readily apparent by looking at the indicator if the nuts are still in the correct mounting position, or if the wheel requires a maintenance operation. Such devices however are just indicators, that is they do not allow in any way to prevent the rotation of the nuts, but simply indicate when the rotation has occurred and to what extent, so as to advise of the need to intervene on the tightening of the nuts. It is also frequent that the indicator, just because of the roads conditions that cause the loosening of the nuts, escapes from its seat, or it happens that it is covered with dirt, thus losing also its usefulness as an indicator. Finally, this type of device, even when it maintains its initial visibility, provides safety only if it is actually checked by a maintenance worker or by the driver of the vehicle, who then proceeds immediately to remedy the possible loosening of the nuts.

Recently devices have been also proposed that are described as capable of joining to the indicating function also the locking function of the fastening nuts. An example is given by the system described in the International patent application published as No. WO 2013/049913, consisting of a set of devices with a central toothed ring body, intended to surround the nut and engage with it, from which two portions branch off in opposite directions, the first of which has the distal end adapted to engage with a second portion of an adjacent device creating a cover on the first portion provided with an indicator signal, thus obtaining a set of devices joined together. When a fastening nut rotates beyond a certain degree, the ring device engaged on it also rotates together with the nut, thus moving the second portion which leaves uncovered the indicator. This system has the central ring provided with a cut in the perimeter to allow insertion, and it is so structured as to let the device be free to rotate following rotation of the nut. It is therefore evident that this is an indicator, without any locking function on the nuts; this assertion is corroborated by the fact that the materials proposed (various examples of plastic and composite materials), in addition to the structure, would be completely inadequate to perform a locking function and to prevent the rotation of the nut.

GB 2356908 and GB 2394265 describe devices for blocking the wheels nuts of vehicles with the aim of reducing their tendency to loosening over time.

For the above said reasons it is therefore still felt in the art the need to have available a device that is really efficacious in locking the wheels nuts of vehicles, and ensure the safety required in particular for heavy vehicles for the transport of people, such as buses and coaches.

### SUMMARY OF THE INVENTION

Scope of the present invention is to provide a safety device for vehicle wheels efficacious in locking the fastening nuts of the wheels to the vehicle axis, which is easy to assemble/disassemble and allows not to carry out a continuous maintenance in order to guarantee an adequate level of safety.

A further scope of the present invention is to provide a method for locking the wheel nuts of vehicle wheels by means of a device, which is robust, efficacious, easy to be mounted and removed, and not requiring maintenance.

These and further scopes are achieved by the device according to the present invention, whose essential characteristics are defined in the first of the attached claims. Further important characteristics are defined in the dependent claims.

### BRIEF DESCRIPTION OF THE DRAWINGS

The features and advantages of the safety device according to the present invention will be illustrated in the following exemplary and non-limiting description of embodiments thereof, with reference to the attached figures wherein:

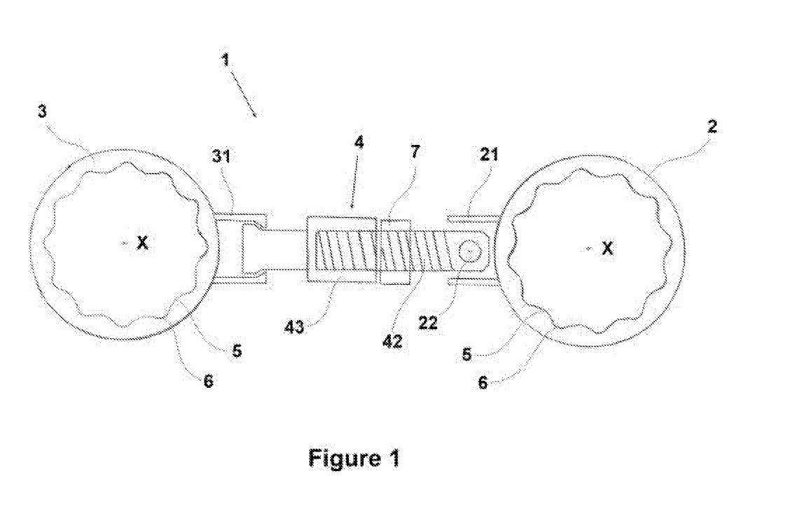

the FIG. 1 shows a top view of an embodiment of the device of the invention;

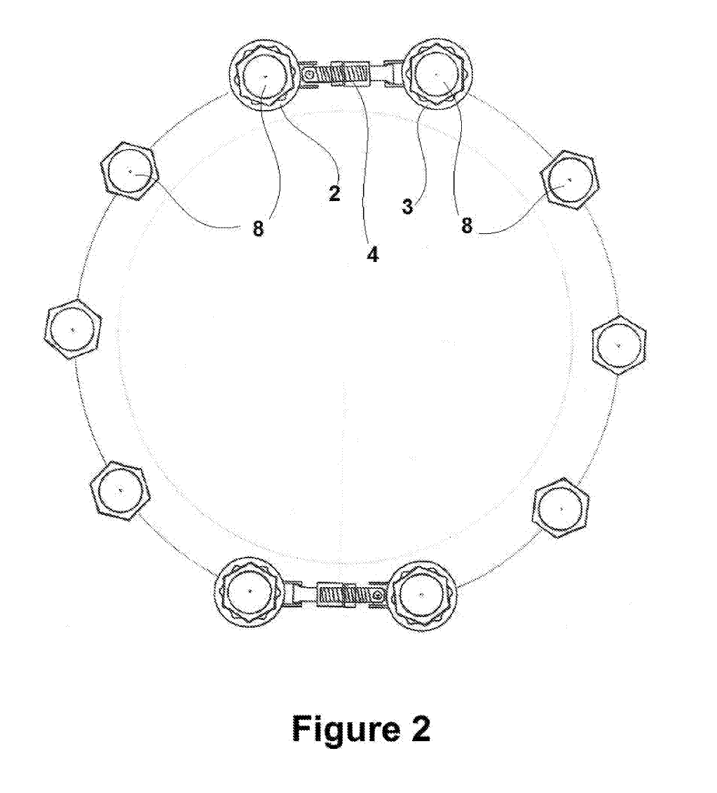

the FIG. 2 is a schematic view of a wheel with two of the devices of the invention of FIG. 1, mounted on the wheel nuts;

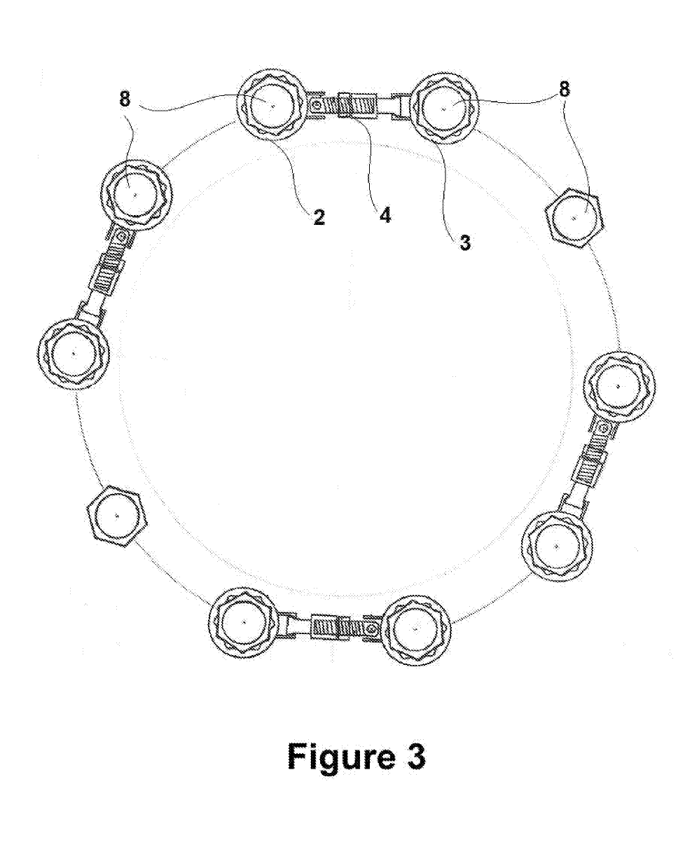

the FIG. 3 is a schematic view of a wheel with four of the devices of the invention of FIG. 1, mounted the wheel nuts.

### DETAILED DESCRIPTION OF THE INVENTION

With reference to said figures, and in particular for now to the FIG. 1, the device 1 for locking wheel nuts according to the invention comprises two ring elements 2,3 adapted to engage around said nuts and placed each on the opposite side with respect to an elongated body 4 having adjustable length, that connects said ring elements, so that the ring element 3 is free to rotate in any directions with respect to the elongated body itself, while the other ring element 2 is connected to the elongated body 4 so that it is free to perform only a translational movement on a plane perpendicular to the central axis X of said ring element 2.

Typically, the ring elements 2,3 have an internal surface provided with grooves 5 and reliefs 6 parallel to a central axis X of each ring, which form a toothed inner surface, ideal to grip the sides of the wheel nuts, around which they have to engage. Also the inner diameter of each ring 2,3 is commensurate with the diameter of a nut for vehicle wheels, so that the present device can be positioned by surrounding two adjacent nuts with the two rings 2,3 of the device until the central axis X of the rings coincides with the axis of the nuts.

With reference to the embodiment illustrated in particular in FIG. 1, the elongated body 4 is connected with its ends to the two ring elements 2,3, by means of their two hollow portions 21,31 extending from an edge of the two respective ring elements. According to such preferred embodiment, the elongated body 4 comprises a first screw stud portion 42 connected to a hollow portion 21 of the element 2 so that the elongated body can perform only a translational movement on the plane perpendicular to the central axis X of the ring element 2; such connection is for instance accomplished by a pin 22 settled inside said hollow portion 21 and inserted in a suitable though hole at the proximal end of the screw 42; alternatively, such connection can be advantageously accomplished by an elastic plug, typically made of spring steel, able to be pressure-inserted inside said hollow portion 21 and in a special through hole at the proximal end of the screw 42. In such preferred embodiment, moreover, the elongated body 4 comprises a second nut portion 43, intended for the connection to a hollow portion 31 of the ring element 3 so that such element is free to rotate around the elongated body 4, for example by a spherical joint connection wherein said portion 43 has the end proximal to said ring element 3 of rounded shape, inserted in the hollow portion 31; the nut portion 43 is connected via a thread to the screw stud 42, such connection further allowing to easily adjust the length of the elongated body 4 by simply tightening the nut to shorten the body 4 or unscrewing it to increase the length.

According to a particularly preferred embodiment, the device of the invention further comprises on the elongated body 4 a safety nut 7 that, screwed subsequently on the nut portion 43 on the screw stud 42, blocks further the screwing position reached, preventing any spontaneous unscrewing for example due to vibrations.

Thanks to its particular structure, the present device is therefore suitable for use on pairs of nuts that are more or less distant between each other, with different inclinations and different positions of the nuts edges, and the mounting (and removing) operations of the device on any pair of nuts is particularly effortless. Once the ring elements 2,3 are positioned so as to surround a pair of adjacent nuts, by operating on the nut portion 43 of the elongated body 4, the length of the elongated body itself can be adjusted to tension the device, then the safety nut 7 is screwed until the nut portion 43 is blocked in this position. Whenever it is required to remove the device, the safety nut 7 can be simply unscrewed, if present, then unscrew the nut portion 43 extending the elongated body 4 to loosen the ring elements that, at this point, can be easily removed from the wheel nuts.

Following application of the device of the present invention on wheels of various type mounted on heavy vehicles, an excellent result was observed for the locking of wheel nuts even by application of just two devices of the invention on two pairs of adjacent nuts, without the need of applying the device on each nut or pair of nuts, as it is indeed necessary for the known devices; it is only preferable that the two devices are symmetrically positioned with respect to each other so that they do not weigh on the wheel balancing. In general, just because of the wheel balancing, it is preferable to mount an even number of devices on a same wheel, symmetrically positioned with respect to each other: for example, on a common configuration with ten nuts, two of the present devices can be mounted as illustrated in the attached FIG. 2, each device being mounted on a pair of adjacent nuts 8, the two pairs being placed on opposite sides so as to not create any weigh unbalancing, not even a minor unbalancing, on the wheel. Alternatively, on a configuration of this type, also four devices 1 can be mounted, as shown in FIG. 3, or five devices to cover all fastening nuts 8.

The connections of the ring elements 2,3 to the elongated body 4 can be accomplished also by means of different connections from the above described spherical joint connections and the screw stud connections, in accordance to what implementable by any person of ordinary skills in the art, provided that at least a ring element of the device is free to rotate with respect to the elongated body 4.

Suitable materials for the manufacture of the present device are in general the metal materials used for the mechanical structures. Amongst them there is steel, in particular the hardened steel.

The present invention therefore allows to overcome the problems involved in the manufacture of a device for locking nuts of vehicles wheels that is robust and relatively light, that allows an efficacious block of the nuts for a long time without requiring continuous checks and maintenance, that can be easily mounted and at the same time can be easily removed for a possible wheel replacement or for balancing operations or similar.

The present device is moreover manufactured substantially as a single piece thus avoiding any undesirable contacts between moving parts during use, and it may moreover easily interface with the parts to which it has to be connected, adapting to any kinds of tyre rims and wheels, without creating too much encumbrance or load on the wheel.

The present device was made with the aim of achieving an efficacious locking of the nuts of vehicles wheels and securing an adequate level of safety in particular for the vehicles for transporting people, without having to undergo continuous maintenance operations. The applicability of the device may be clearly not limited to the field of such vehicles, but it can be extended to all the fields wherein locking of fastening nuts is required.

The present invention has been described up to here with reference to preferred embodiments thereof. It should be understood that there can be other embodiments that derive from the same inventive core, all of which are covered by the scope of protection of the claims given hereafter.

1. A device for locking the wheel nuts of motor vehicles, comprising two ring elements adapted to engage around said nuts and placed each on the opposite side with respect to an elongated body having adjustable length, said ring elements being connected to each other by said elongated body so that a ring element is free to rotate in any direction with respect to said elongated body, while a ring element is free to perform only a translational movement on a plane perpendicular to a central axis X of said ring element.

2. The device according to claim 1, wherein said ring elements have an internal surface with grooves and reliefs parallel to a central axis X of said ring elements, which form a toothed inner surface suitable to grip said nuts.

3. The device according to claim 1, wherein said elongated body is connected with its ends to said ring elements by means of their two hollow portions extending from an edge of the two respective ring elements, and comprises a first portion being a screw stud connected to said hollow portion of the element so that the elongated body can perform only a translational movement in the plane perpendicular to the axis central X of said ring element, and a second portion being a nut, intended for connection to said hollow portion of said ring element so that said element is free to rotate around the elongated body; said nut portion being connected via a thread to said screw stud, said connection allowing also the adjustment in the length of said elongated body by simply tightening the nut to shorten the body or unscrewing to increase the length.

4. The device according to claim 3, wherein said elongated body and said first screw stud portion are connected through an elastic plug pressure-inserted within said hollow portion and inserted in a special through hole at the proximal end of said screw.

5. The device according to claim 3, wherein said elongated body and said second nut portion are connected by means of a ball joint connection in which said portion has the proximal end to said ring element of rounded shape, inserted in said hollow portion.

6. The device according to claim 3, wherein said elongated body is further provided with a safety nut that is screwed on said screw stud portion after said nut portion to further block the screwing position reached, preventing any spontaneous unscrewing.

7. A method for locking the nuts of motor vehicle wheels, comprising mounting a device as defined in claim 1 on a pair of adjacent nuts by adjusting the length of said elongated body and positioning of said ring elements of the device to surround said pair of adjacent nuts.

8. The method according to claim 7, comprising mounting said devices in number of two and placed in a symmetrical manner so as not to alter the wheel balance.
